(19) United States
(12) Patent Application Publication
(10) Pub. No.: US 2016/0025056 A1
(43) Pub. Date: Jan. 28, 2016

(54) DIESEL FUEL INJECTOR CLAMP

(71) Applicant: Ford Global Technologies, LLC, Dearborn, MI (US)

(72) Inventors: Ronald Paul Smaldone, Livonia, MI (US); Narendra S. Desai, Plymouth, MI (US); Glen Weber, Northville, MI (US); Peter Schaefer, Brownstown, MI (US)

(21) Appl. No.: 14/338,283

(22) Filed: Jul. 22, 2014

(51) Int. Cl. F02M 61/14

(52) U.S. Cl. CPC F02M 61/14

(57) ABSTRACT

Methods and systems are provided for a fuel injector clamp for fixing a fuel injector to an engine component such as a cylinder head. Fuel injector clamps can be made from a variety of manufacturing processes, but some processes are more limiting in terms of material selection, structural properties of the clamp, and overall cost. A fuel injector clamp for use in a diesel engine is provided that has a design conforming to a stamping manufacturing process to increase the strength of the clamp as well as increase reliability while reducing the cost.

### FIELD

The present description relates generally to methods and systems for a fuel injector clamp for holding a fuel injector in position in a diesel internal combustion engine.

### BACKGROUND/SUMMARY

Engine systems that utilize fuel injection include a multitude of fuel injectors configured to inject fuel into particular areas of the engine. In port fuel injection systems, fuel is injected outside a cylinder in an intake manifold or runner prior to an intake valve that draws air-fuel mixture into the cylinder. In direct injection systems, fuel is injected directly into the cylinder without first traveling through ports, valves, or other passageway components. Port and direct fuel injection systems may be used separately or in combination depending on the particular engine system. The fuel injectors (of both types of fuel systems) are often joined by a common fuel rail that contains pressurized fuel. The fuel rail may contain individual pockets, seats, or tubes to connect each fuel injector to the rail as well as a common fuel inlet to supply the rail with fuel.

Each injector is held in place by a clamp, bracket, or similar retaining device such that the injector is held in position to inject fuel into the appropriate space while remaining substantially fixed to the surrounding structure. The surrounding structure may include the engine block, cylinder head, frame, or other similar feature. The retaining device may include a section for securing the device to the surrounding structure via a fastener such as a bolt, while another section of the device includes clamping features to hold the fuel injector in position. The clamping features may include arms, protrusions, or other structure that form passageways or cavities through which the fuel injector fits and maintains physical connection with the clamping features. By using the retaining devices to substantially fix the fuel injectors in place, the fuel injectors may maintain contact with the engine as well as the tubes or pockets that bridge between the fuel injectors and fuel rail. As such, a substantially rigid connection is created between the fuel rail, fuel injectors, and engine.

One example retaining device to fix the fuel injector is shown by LeVey et al. in U.S. 2013/0174810. Therein, a bracket assembly is configured to secure a fuel injector to a mounting frame within a vehicle. The bracket assembly includes a single main body formed from a single piece of stamped material. The main body further includes a nozzle-engaging member configured to retain a nozzle of the fuel injector while a fastener-engaging member is configured to retain a fastener that secures the main body to the mounting frame. In particular, the bracket includes two nozzle-engaging prongs that are bent and formed to retain the nozzle. The prongs come together at a crimped wall, and is in turn connected to an outwardly-bowed walls that curve back toward a center line into trailing truss fins. The fins are connected at a far end of the bracket by an integral folded end that is generally perpendicular to the fins. Generally, the single sheet of metal that forms the bracket is folded about the folded end to from the symmetrical bracket, which may be symmetrical about the center line. In other words, the two protrusions defined by the prongs, walls, and fins form the passages shaped to retain the injector nozzle and fastener.

However, the inventors herein have recognized potential issues with the above bracket system. As one example, the design using the two prongs may provide thicknesses and widths that can only sustain a limited amount of stress, thereby reducing the overall strength of the bracket. As described by LeVey et al., the bracket has a vertically-folded thin metal design with a trimmed truss shape, using less material than other clamp designs. The thin metal design may reduce the overall strength of the bracket compared to designs that utilize more material with substantially the same shapes and locations of the nozzle and fastener retaining passages.

In one example, the issues described above may be at least partially addressed by a fuel injector clamp, comprising: a main body with a substantially planar top surface, the top surface including a hole protruding through the top surface into a cavity at an interior of the main body; a front body including a first protrusion and a second protrusion projecting from the main body; and a rear section extending from the main body to a rear surface at a lower height than the top surface. In this way, the fuel injector clamp can be made from different manufacturing processes which may include stamping. As such, the clamp can contain geometrical features such as fillets, curvature, and thicknesses conducive to the steps for stamping the clamp.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a simplified schematic diagram of multi-cylinder engine 100 with an associated fuel system.

FIG. 2 shows a front perspective view of a diesel fuel injector clamp according to an embodiment of the present disclosure.

FIG. 3 shows a side view of the diesel fuel injector clamp of FIG. 2.

FIG. 4 shows a cross-sectional view of the diesel fuel injector clamp of FIG. 3.

FIG. 5 shows a top view of the diesel fuel injector clamp of FIG. 2.

FIG. 6 shows a bottom view of the diesel fuel injector clamp of FIG. 2.

FIG. 7 shows a rear perspective view of the diesel fuel injector clamp of FIG. 2.

FIG. 8 illustrates a flow chart of a method for selecting a fuel injector clamp design and manufacturing the clamp. FIGS. 2-7 are drawn approximately to scale, although other relative dimensions may be used.

### DETAILED DESCRIPTION

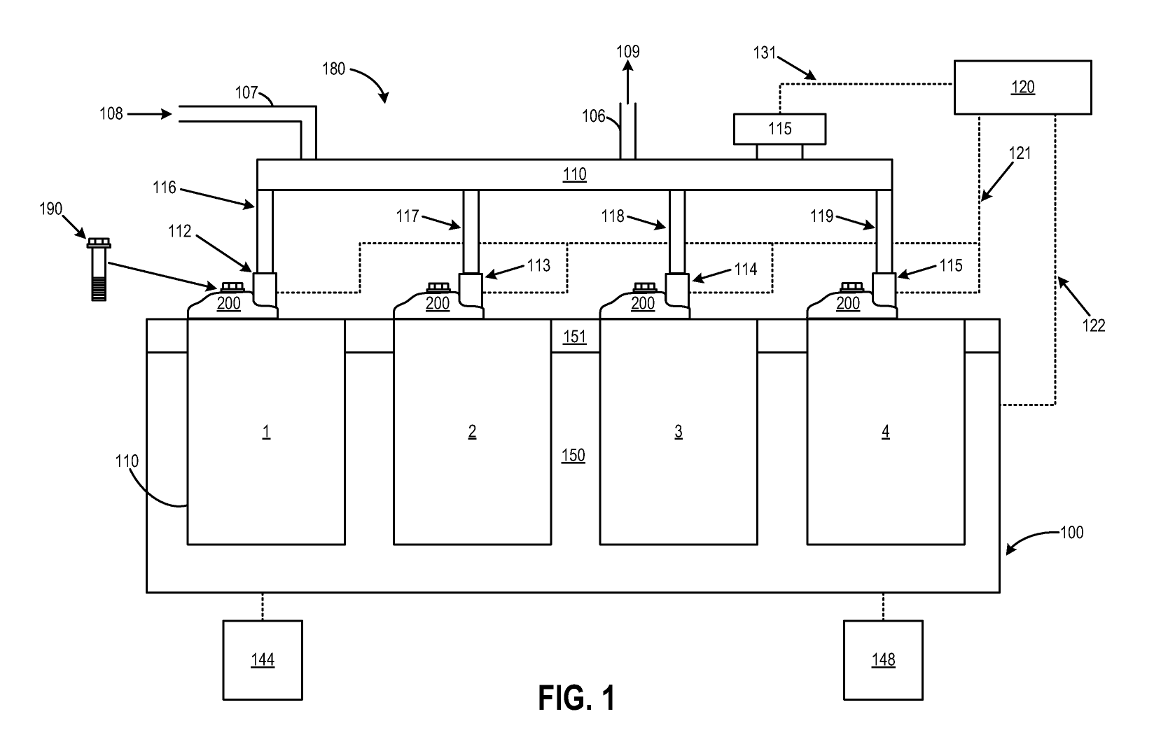

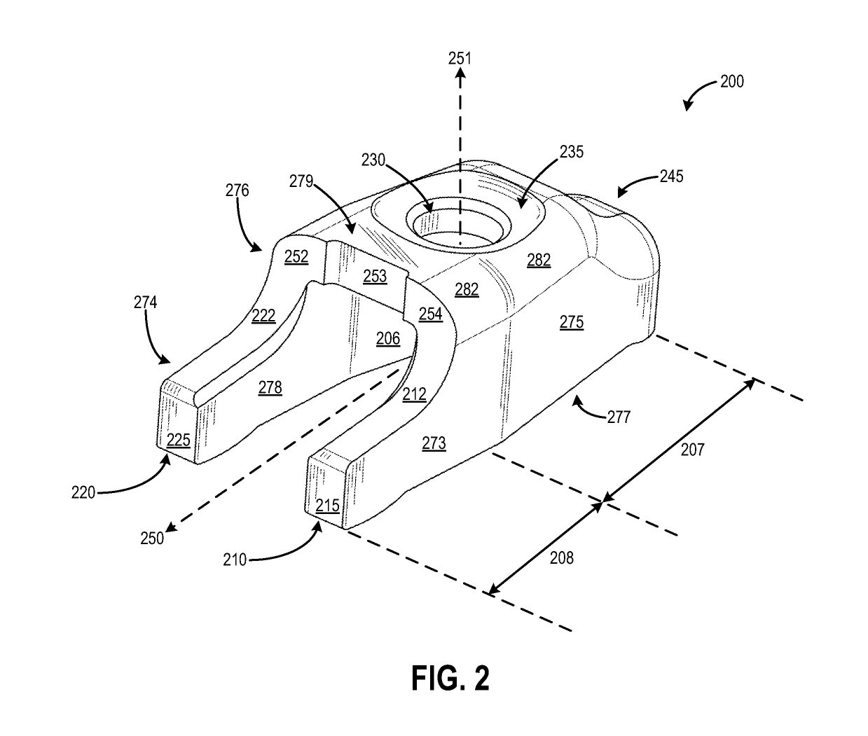

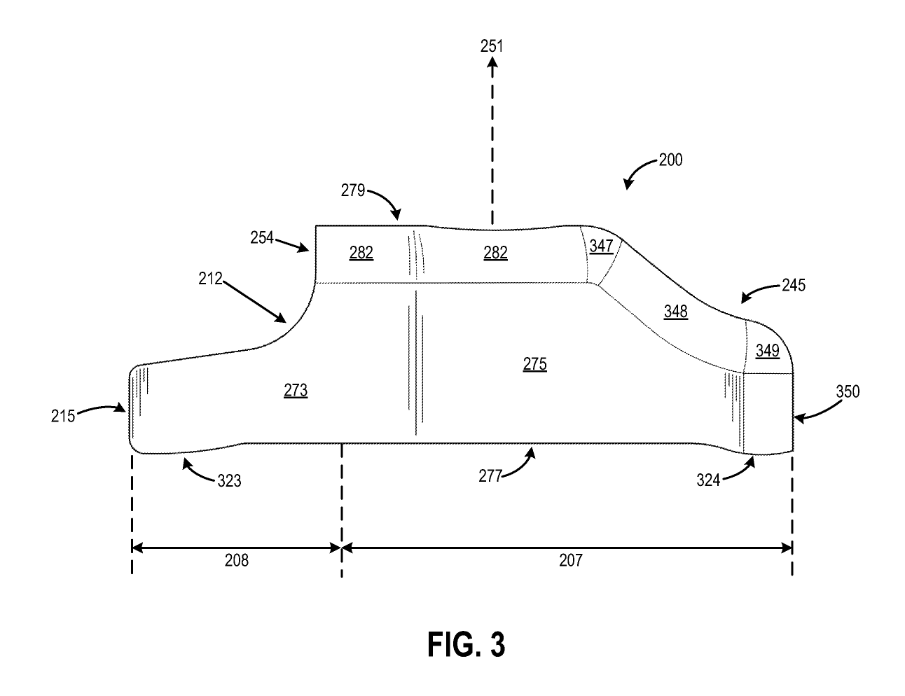

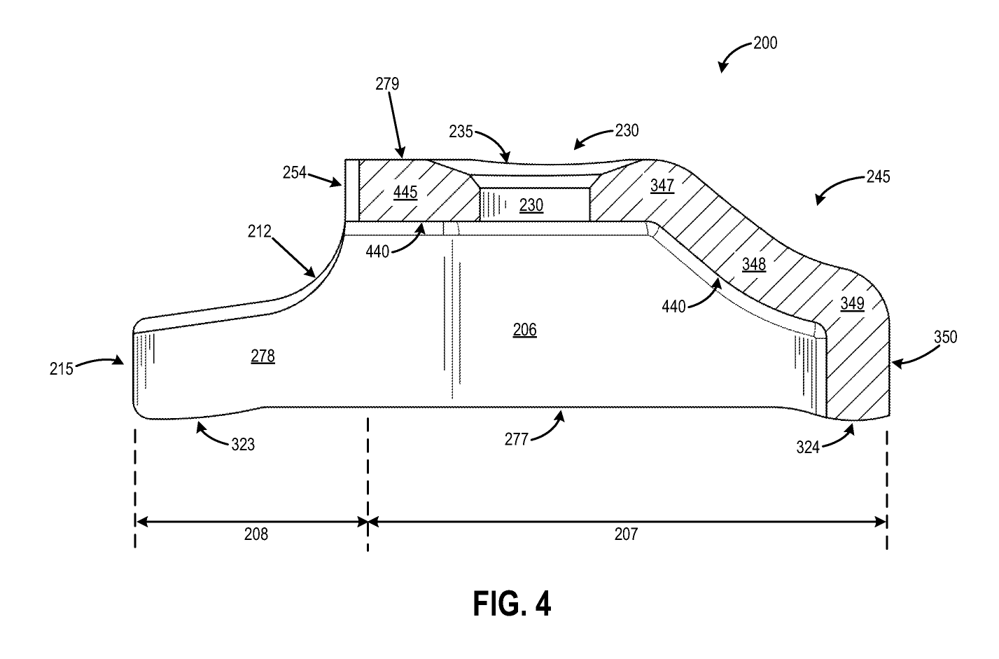

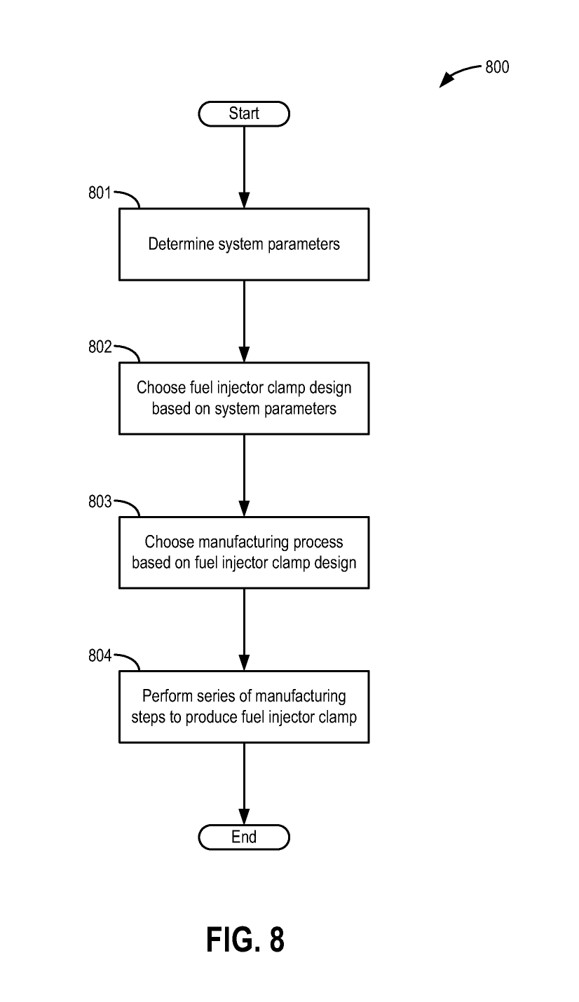

The following description relates to systems for securing fuel injectors of a fuel system to an engine of a vehicle. In particular, a clamp design is described below that is used to hold the fuel injectors in specified position, wherein a fastener provides the compressive force between the clamp, fuel injector, and portion of the engine the fuel injector is inserted in. FIG. 1 shows a simplified schematic diagram of an engine and related components. FIGS. 2, 3, and 5-7 show several perspective, side, top, and bottom views of a diesel fuel injector clamp while FIG. 4 shows a cross-sectional view from the same viewing angle as seen in FIG. 3. Lastly, FIG. 8 illustrates a flow chart of a method for selecting and manufacturing a fuel injector clamp.

FIG. 1 shows a simplified schematic diagram of a multi-cylinder engine 100 in accordance with the present disclosure. As depicted in FIG. 1, internal combustion engine 100 includes cylinders 110, labelled as cylinders 1, 2, 3, and 4, which are coupled to intake passage 144 and exhaust passage 148. Intake passage 144 may include common devices such as an electronic throttle valve, intercooler, and compressor. Exhaust passage 148 may include common devices such as an emissions control device, exhaust gas recirculation system, and turbine coupled to the compressor via a common shaft.

Cylinders 110 may be configured as part of cylinder head 151 that is in turn coupled to cylinder block 150. In FIG. 1, cylinder block 150 is shown with 4 cylinders, comprising cylinders 1-4, in an inline configuration. In some examples, cylinder block 150 may have more or fewer cylinders, for example six or eight cylinders. In some examples, the cylinders may be arranged in a V configuration or other suitable configuration. In particular, the cylinders 110 are formed when cylinder block 150 and cylinder head 151 are joined together, which may be a removable connection in some engine systems. In other words, cylinder head 151 may form a top portion of cylinders 110 while cylinder block 150 may form a bottom portion of the cylinders.

Engine 100 may be controlled at least partially by a control system including controller 120, attached to the engine via an electrical connection 122. A vehicle operator and input device may produce signals to input to controller 120 for further aiding in controlling engine 100. Controller 120 may be a microcomputer, including appropriate components such as a processor, a multitude of input/output ports, an electronic storage medium for executable programs and calibration values shown as read-only memory in some examples, random access memory, keep alive memory, and a data bus. Controller 120 may receive various signals from sensors coupled to engine 100 as well as other components. Furthermore, controller 120 may be programmed with computer-readable data representing instructions stored in non-transitory memory for executing a number of methods for providing control of the engine 100 and other vehicle systems.

Cylinder head 151 is shown coupled to fuel system 180. Cylinders 1-4 are shown coupled to fuel injectors 112, 113, 114, and 115, respectively. In this example embodiment, fuel injectors 112, 113, 114, and 115 (112-115) are depicted as direct fuel injectors. In this sense, the injectors 112-115 are positioned adjacent to their respectively cylinders 1-4 such that fuel is injected directly into the combustion chambers of each cylinder. In some embodiments, in addition to the direct fuel injectors shown, intake passage 144 and the associated intake system may include a series of port fuel injectors such that one injector is positioned upstream of a respective cylinder. As such, both port and direct fuel injection may be utilized to optimize engine performance. Each fuel injector 112-115 may be configured to deliver a specific quantity of fuel at a specific time point in the engine cycle in response to commands from controller 120 sent to the injectors via electrical connection 121. One or both of the port and direct fuel injectors for each cylinder may be utilized to deliver combustible fuel to cylinders 110 during each combustion cycle. The timing and quantity of fuel injection may be controlled by controller 120 as a function of engine operating conditions.

Fuel injectors 112-115 are shown coupled to a fuel rail 110 via conduits 116, 117, 118, and 119, respectively. Fuel rail 110 may be coupled to a high-pressure fuel line 107. Pressurized fuel may enter line 107 in the direction indicated by arrow 108. Although not seen in FIG. 1, fuel line 107 may be coupled to a fuel tank, additional fuel passages, and one or more fuel pumps that pressurize and send fuel through line 107 into fuel rail 110. Fuel rail 110 may include a plurality of sensors for estimating (i.e., measuring) quantities of the fuel and fuel system, such as a temperature sensor and a pressure sensor. Similarly, the fuel tank, fuel passages, and pumps may also include a variety of sensors. In particular, a pressure sensor 115 is attached to the periphery of fuel rail 110 for detecting the fuel pressure within the fuel rail. In this way, by providing fuel rail pressure data to controller 120 via connection 131 leading from the pressure sensor 115, the data can be used to at least partially control fuel system 180 to provide the desired pressure of fuel to the fuel rail. In some embodiments, fuel system 180 may contain a liquid fuel, such as gasoline, diesel, ethanol, E85, etc.

A fuel rail pressure relief passage 106 leads away from fuel rail 110 as directed by arrow 109. The relief passage 106 may contain a check valve or other type of selectively-operable valve that opens when pressure in fuel rail 110 exceeds an upper threshold, whereupon the check valve of passage 106 opens to allow pressure to be relieved from the fuel rail. The excess fuel, travelling in the direction shown by arrow 109 may re-enter upstream components of fuel system 180, such as the fuel tank and pump that are fluidically coupled upstream of high-pressure fuel line 107. In some examples, rather than being connected to fuel rail 110 via conduits 116-119 (or tubes or similar passage), fuel injectors 112-115 may be directly coupled to the fuel rail via multiple pockets or seats. In this way, the fuel rail 110 itself contains the fuel injectors 112-115.

Each fuel injector 112-115 is substantially fixed to cylinder head 151 via a fuel injector clamp 200. In the case of engine 100 being a diesel engine, clamps 200 may be alternatively referred to as diesel fuel injector clamps. As seen, clamps 200 may be positioned adjacent to each fuel injector 112-115 such that the injectors are held in place along cylinder head 151. In particular, an injection portion of each injector may be inserted into the respective cylinder 1-4 while an upper portion of each injector may be held by clamp 200. As discussed above, the end of each injector 112-115 may be connected to fuel rail 110 via conduits 116-119 or other similar structures. Each injector clamp 200 may contain a first section that grips one of the fuel injectors and a second section that contains a hole through which a fastener can secure the clamp to cylinder head 151. Each clamp 200 includes a fastener 190, such as a bolt or other similar component that inserts through the clamp and threads into cylinder head 151 to provide compressive force between the clamp and cylinder head. In other embodiments, fastener 190 may be replaced by other securing devices that do not utilize threads, such as pins or other locking mechanisms. In this way, clamps 200 provide substantially rigid connections between injectors 112-115 and cylinder head 151.

The timing, flow rates, and injection of fuel system 180 may be coordinated to coincide with events occurring during the combustion sequence. Further, the timing, flow rates, and injection of fuel system 180 may be determined as a function of engine operating conditions or as a function of the fuel in the system. Further, spark timing and boost pressure may be adjusted in accordance with the timing and flow rates of the direct injection of the fuel. It is noted that engine 100, fuel system 180, and associated components of FIG. 1 are shown to provide a simple, illustrative example of an engine system and where fuel injector clamps 200 are positioned relative to other engine components. As such, many components and geometrical relations are not included in the engine system of FIG. 1. For example, cylinder block 150 may include an oil pan attached to a bottom surface while a camshaft system is attached to cylinder head 151. Additionally, each cylinder 1-4 may be configured with an ignition system such as a spark plug or a glow plug for diesel engine applications. Furthermore, while many components of FIG. 1 are simply shaped as rectangular features, it is understood that more complex geometries may exist in practice.

FIG. 2 shows a front perspective view of a diesel fuel injector clamp 200. Clamp 200 may be similar to or substantially the same as clamp 200 shown in FIG. 1. The clamp includes several surfaces and thicknesses that define the shape of the clamp. In particular, the clamp 200 is symmetric about a central axis 250 and further includes a main body 207 comprising a generally curved thickness that forms an interior cavity 206. Furthermore, a generally circular hole 230 is formed in a top surface 279 of the main body 207, wherein a center of the hole is defined by a vertical axis 251. The hole 230 protrudes through the thickness of body 207 such that the interior cavity 206 is continuous with the exterior of the clamp 200 via at least the hole 230. While a rim of the hole 230 is not contiguous with the top surface 279, a recessed feature 235 connects the rim of the hole to the top surface. In other words, the recessed feature 235 provides a slanted protrusion from the hole 230 up to the plane defined by the top surface 279 since the hole lies in a less vertical direction than the top surface, as shown by the direction of vertical axis 251. The recessed feature 235 surrounds the circumference of hole 230 and is therefore also generally circular in shape. In some embodiments, hole 230 may be tapped (i.e. containing receiving threads of a fastener) while in other embodiments, hole 230 is untapped.

Main body 207 also includes a rear section 245 that is shorter in height along the vertical direction 251 such that surface 279 is located above the rear section. The rear section 245 is described in more detail in later figures where the section is more clearly visible. Adjacent to the recessed feature 235 and included in the top surface 279 a number of fillets 282 provide rounded corners to the top region of the clamp 200. The fillets 282 may serve to round out perpendicular edges of clamp 200 such that cutting injury to an operator is reduced during installation, servicing, and/or removal of the clamp. Other unlabeled fillets may be present throughout clamp 200 in areas other than those marked by fillets 282. A first side surface 275 is visible in FIG. 2, which is substantially planar in shape and parallel to the vertical axis 251. Although not visible, a second side surface 276 is located opposite to and offset from the first side surface 275 according to the symmetry of the clamp 200 about central axis 250. Lastly, a bottom surface 277 is located on an underside of the clamp 200 (not visible in FIG. 2), wherein the bottom surface is generally planar and parallel to top surface 279.

An indent 253 is also included in the main body 207 that marks an outside edge of the main body. The indent 253 is generally rectangular in shape and is offset from surrounding sidewalls 252 and 254 that also aid in defining the outside edge of the main body 207. Indent 253 is substantially perpendicular to top surface 279. Portions of sidewalls 252 and 254 are also substantially perpendicular to top surface 279 while the rest of the sidewalls are substantially perpendicular to fillets 282 as the sidewalls 252 and 254 follow the contours of fillets 282. In addition to the plurality of fillets 282, other curved features such as chamfers may be included in clamp 200 for rounding sharp edges of the clamp where surfaces meet.

Coupled to main body 207 is a front body 208 that is integrated into the same material as main body 207 in some embodiments. In other words, a contiguous piece of material defines clamp 200 which includes both main body 207 and front body 208, which are defined and shown in FIG. 2 for ease of understanding the various geometrical features of the clamp. In a similar fashion as described with regard to main body 207, front body 208 is also symmetric about central axis 250. Front body 208 comprises two protrusions that extend from the main body 207. A first protrusion or leg 210 extends away from the main body 208 near first side surface 275 while a second protrusion or leg 220 extends away from the main body near second side surface 276. In particular, as seen in FIG. 2, a first outward face 273 of first leg 210 is substantially planar and shares the same plane as first side surface 275. While not completely visible in FIG. 2, the planar sharing of an outward face of second leg 220 and second side surface 276 is also present. In particular, a second outward face 274 of second leg 220 is substantially planar shares the same plan as second side surface 276. An interior surface 278 can be seen in the interior side of second leg 220. The interior surface 278 includes the surfaces adjacent to cavity 206. Although not visible in FIG. 2, the first leg 210 also includes interior surface 278 due to the symmetry of clamp 200 about central axis 250. Substantially planar may include the surface being approximately flat, for example within 10% of a flat plane in one example.

First leg 210 includes a substantially planar front face 215 parallel to a similarly-placed front face 225 of second leg 220. In some embodiments, front faces 215 and 225 may be coplanar. In other embodiments, front faces 215 and 225 may not be coplanar nor parallel. In the present embodiment of FIG. 2, front faces 215 and 225 are parallel to vertical axis 251. Furthermore, the outward faces 273 and 274 may be coplanar with first side surface 275 and second side surface 276, respectively, as shown in FIG. 2. In other embodiments, faces 273 and 274 may not be co-planar with surfaces 275 and 276, respectively, while still sharing continuous material that has generally curved shapes. A first concave surface 212 defines an upper surface of first leg 210 and bridges the space between first front face 215 and sidewall 254. As seen, first concave surface 212 lies parallel to central axis 250 near first front surface 215 while the concave surface lies parallel with sidewall 254 as it joins sidewall 254 (parallel to vertical axis 251). In other words, the orientation of first concave surface 212 changes about 90 degrees between first front surface 215 and sidewall 254. A second concave surface 222 is also present on clamp 200, wherein the second concave surface may be substantially identical to first concave surface 212 due to the symmetry about central axis 250.

FIG. 3 shows a side view of the diesel fuel injector clamp 200. Many of the features of FIG. 2 are visible in FIG. 3, while other features not visible in FIG. 2 are described hereafter. As seen, bottom surface 277 is substantially planar with the exception of the regions near the ends of clamp 200. In particular, at the front end of clamp 200 (closest to front body 208) a front bottom surface 323 connects between the bottom surface 277 and first and second front faces 215 and 225, wherein the second front face is located behind the first front face in the view of FIG. 3. As seen, front bottom surface 323 is generally curved and slopes in the negative vertical direction (opposite to depicted arrow 251) as it meets with the lower portion of front surface 215. Similarly, near the back end of clamp 200 on the rear section 245, a rear bottom surface 324 connects between the bottom surface 277 and a rear surface 350. Furthermore, rear bottom surface 324 also curves in the negative vertical direction to meet with the lower portion of rear surface 350. It is noted that other shapes of the bottom side of clamp 200 are possible. For example, in other embodiments, bottom surfaces 323 and 324 may be substantially flat and planar with bottom surface 277 while in another embodiment bottom surfaces 323 and 324 include flat profiles that slant to bridge between surfaces 215 and 351 to bottom surface 277, respectively.

As seen, rear surface 350 is substantially parallel to vertical axis 251 as well as first front surface 215. A rear filleted section 348 spans the distance between top surface 279 and rear surface 350. Furthermore, filleted section 348 travels opposite to the vertical direction from top surface 279 to rear surface 250 since the top surface is located at a more vertical position than the rear surface. A corner fillet 347 is positioned in between filleted section 348 and fillet 282 to provide a smooth transition between the horizontal positioning of top surface 279 and the sloping decline of filleted section 348. Similarly, an end fillet 349 provides a smooth transition between filleted section 348 and rear face 350. From the view of FIG. 3, end fillet 349 has a generally circular profile such that a 90-degree sweep forms between filleted section 348 and rear surface 350. Substantially parallel may include two elements being within 10% of parallel, and substantially perpendicular may include two elements being within 10% of perpendicular.

FIG. 4 shows a cross-sectional view of the diesel fuel injector clamp 200. In particular, the side view is the same as that shown in FIG. 3 with half of the clamp sectioned along the central axis 250. Most of the features of FIG. 3 are shown in FIG. 4. A top wall 445 is located in between sidewall 254 (and 252), hole 230, and top surface 279. Top wall 445 comprises the material forming the thickness of the clamp 200. Equivalently, the combined depth of recessed feature 235 and hole 230 is equal to the thickness (i.e., height or depth) of top wall 445. In some embodiments, the thickness of all areas of clamp 200 may be substantially equivalent to the thickness of top wall 445. The underside of main body 207 of the clamp is visible, labelled as underside 440. Underside 440 refers to the surfaces adjacent to cavity 206 that are substantially parallel to the outside surfaces. For example, a portion of underside 440 and top surface 279 are parallel while underside 440 located near rear portion 245 follows the contours of filleted portion 348. While interior surface 278 refers to the surfaces located adjacent to interior cavity 206 along the sides of clamp 200, underside 440 refers to the surfaces located adjacent to interior cavity 206 along the underside of the top of clamp 200. As such, the thickness of top wall 445 may also be defined as the distance between top surface 279 and the portion of underside 440 directly underneath the top wall. As seen in FIG. 4, corner fillet 347, filleted section 348, and rear fillet 349 also have thicknesses roughly equal to the thickness of top wall 445. Although not discernible in the side view of FIG. 4, cavity 206 refers to the empty space adjacent to interior surface 278, which refers to the solid material located on the inside of clamp 200.

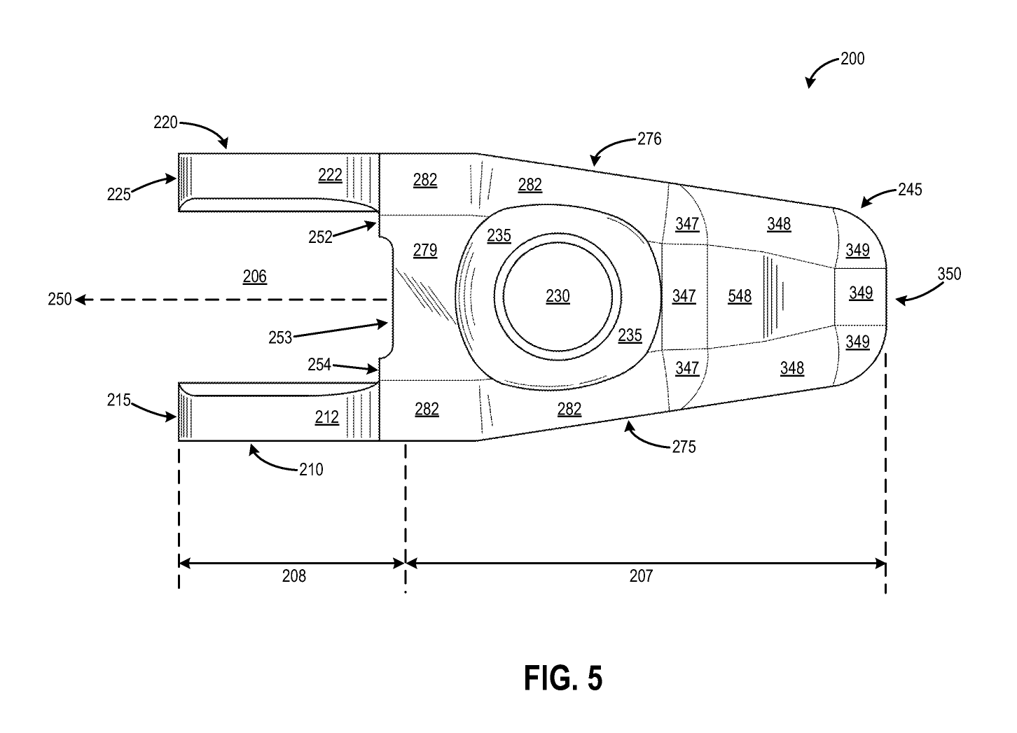

FIG. 5 shows a top view of the diesel fuel injector clamp 200. The symmetry of the clamp 200 about central axis 250 is clearly shown in this view. Furthermore, while not visible in the previous figures, as seen in FIG. 5 the width of the clamp 200 remains substantially constant throughout the front body 208 but gradually decreases along the main body 208 towards the rear section 245 and rear section 350. In other words, the width of clamp 200, as measured perpendicular to the plane defined by the vertical axis 251 and central axis 250, is larger at the interface between the main body 207 and front body 208 than the width at the rear section 245 closest to rear face 350.

Furthermore, while not visible in previous figures, the opposite side of clamp 200 also exhibits features such as fillets 282, 347, and 349 as well as filleted section 348 since the clamp is symmetric about central axis 250. In addition to bridging filleted sections 348 and rear face 350, end fillets 349 also provide rounded edges between the rear face and first and second side surfaces 275 and 276, respectively. A nose section 548 is located in between the filleted sections 348 adjacent to the first and second side surfaces 275 and 276, respectively. The nose section 548 comprises a generally curved and concave shape to follow approximately the same profile as filleted sections 348. The nose section is located in between end fillets 349 and fillets 347 along the direction of the central axis 250. Although generally following the profile of filleted sections 348, nose section 548 can contain additional features such as indentations or bulges to conform to structural requirements of clamp 200. For example, a portion of nose section 548 may contain a planar, circular feature that results from a coining step in a manufacturing process to create the clamp 200. The coined feature is described later in more detail. From the top view, recessed feature 235 has a generally circular profile surrounding hole 230. In other embodiments, the profile of recessed feature 235 may be different (i.e., not circular) to conform to the particular shape and size of top surface 237 and other features of the clamp 200. Cavity 206 is also visible, which is the empty space (i.e., lack of material) located in between first and second legs 210 and 220 as well as the interior of the clamp 200 beneath hole 230.

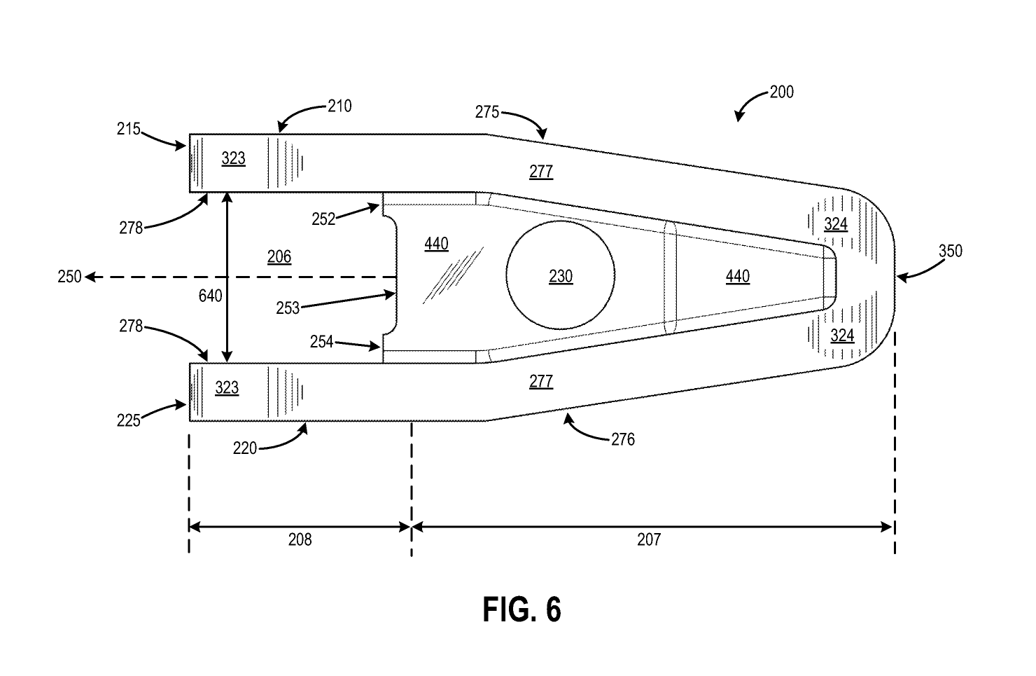

FIG. 6 is a bottom view of diesel fuel injector clamp 200. The entirety of bottom surface 277 is visible from this angle, as well as front bottom surface 323 and rear bottom surface 324. A fuel injector receiving space 640 is hereafter defined as the space created in between first and second legs 210 and 220, respectively. The space 640 may be shaped by legs 210 and 220 in order to effectively hold the fuel injector (not shown) in position when clamp 200 is fixed to the cylinder head, as previously described with regard to FIG. 1. In particular, in the present example space 640 is a portion of cavity 206 created by the material of clamp 200. For example, when the space 640 is filled by the fuel injector, face-sharing and substantially contiguous contact between interior surface 278 and the outer periphery of the fuel injector is provided. Although shown as substantially rectangular in FIG. 6, space 640 may conform to a variety of different shapes depending on the shape of the fuel injector. In a different example, space 640 may be circular wherein interior surfaces 278 are curved to accommodate a circular fuel injector. Other shapes are possible while remaining within the scope of the present disclosure.

Also visible in FIG. 6 is the entirety of underside 440, defining the underside of top surface 279 and the top wall 445 that is sandwiched in between the top surface and underside. Furthermore, as also seen in the top view of FIG. 5, clamp 200 has a larger width near hole 230 than the width near the rear end (near rear surface 350). In this sense, width refers to the dimension parallel to the arrow of space 640, or in other words, the dimension perpendicular to central axis 250.

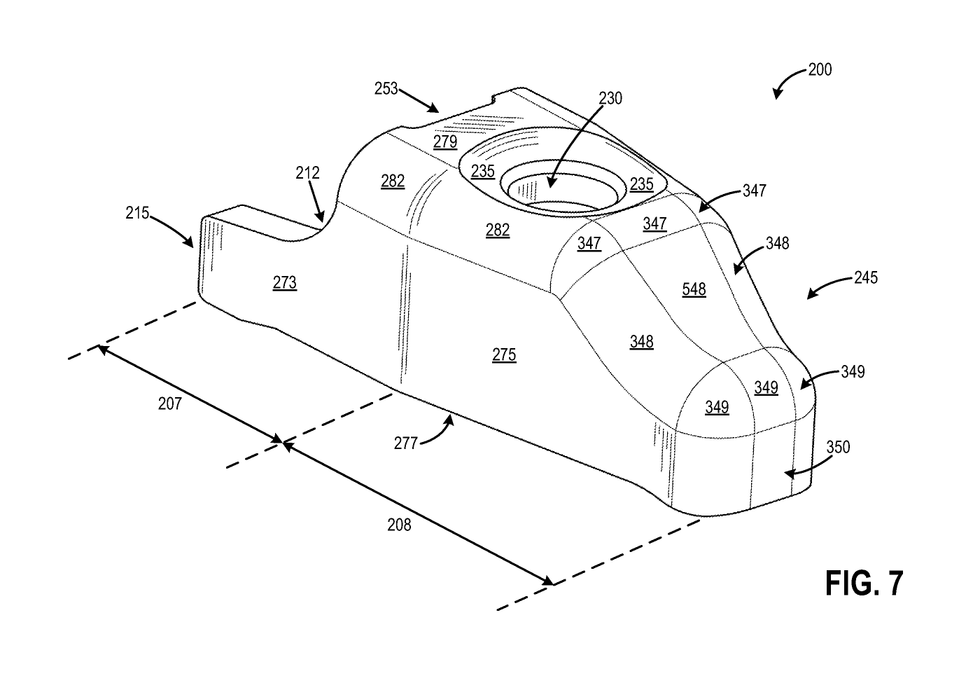

FIG. 7 shows a rear perspective view of the diesel fuel injector clamp 200. From this angle, the curvature of rear portion 245 is more clearly seen, wherein filleted sections 348 and nose section 548 define the height differences between the top surface 279 and the rear section. Furthermore, the intersection between first side surface 275 and rear surface 350 is substantially curved such that the two surfaces do not form a right angle. The smooth (i.e., filleted) interfaces between joining surfaces of clamp 200 may reduce the number of sharp corners, thereby reducing the chance of injuring a technician while installing, removing, and/or replacing the fuel injector clamp.

With other clamp designs, it is common to cast the diesel fuel injector clamp, which may exhibit undesirable qualities. First, casting and similar heat treatment processes may allow for less control over the forming of the clamp compared to other manufacturing methods. For example, dimensional stability of the clamp may degrade after heat treatment from the casting process along with a restriction in materials available to produce a high-quality casted clamp. Furthermore, changes in the clamp design may require expensive changes to the casting process, such as new dies or other similar components. As such, for casting to be economical, a single design may be produced for an extended period of time to create many clamps before switching designs, thereby reducing flexibility in continual improvements to the clamp design.

In this way, with the design of the injector clamp 200 as seen in FIGS. 2-7, the clamp may be conducive to a variety of manufacturing processes, including casting, to form the final clamp. In particular, stamping may be used to create the final shape of clamp 200. In the context of this disclosure, stamping may include a multitude of metal-forming processes that are generally grouped under the stamping category, including bending, blanking, drawing, forming, and coining, among others. Stamping the clamp may leverage several benefits over casting the clamp. First, utilizing a series of simple progressive dies for the stamping process may be easier and more cost-effective than casting. Controlling the stamping process with few steps may be advantageous to casting, which may involve more steps and greater complexity in the casting process. As such, the cost per stamped clamp may be reduced along with increasing the reliability of stamping over casting. Additionally, material selection and heat treatment for the stamped clamp may further lower the cost and improve the quality of the clamp due to better dimensional stability after heat treatment (as compared to casting). Lastly, the number of materials available for stamping may be greater than the number available for casting, thereby allowing for more flexibility with the stamped design regarding material selection.

The diesel fuel injector clamp 200, when manufactured according to the aforementioned stamping process, can be made from a high strength steel. Many casting processes are limited to non-ferrous materials such as aluminum, zinc, magnesium, and copper alloys, while stainless steel alloys can be casted in some settings. However, generally it is difficult and uncommon to cast with high strength (low alloy) steels. For some casting processes, such as permanent mold casting, graphite molds may be used to cast iron and steel parts, but this is also generally uncommon. In comparison, with the current clamp design of clamp 200 that can be stamped, high strength steels can be used as the clamp material, thereby increasing various properties of the clamp over other casted clamp designs. For example, due to the higher strength of steel compared to an aluminum alloy, the clamp 200 (when stamped) may have a longer service life than other designs, thereby reducing maintenance and replacement costs associated with the fuel system and vehicle.

FIG. 8 shows a flow chart depicting a method for selecting a diesel fuel clamp design and manufacturing the clamp, such as clamp 200 shown in previous figures. First, at 801, the method includes determining a number of system parameters. These parameters may include, but are not limited to, number of cylinders and fuel injectors, positioning of injectors relative to the engine and to each other, engine size, vibration and dampening requirements, fuel system layout, and shape of the fuel injectors. Many of the system parameters may be simple observable features of the engine system. Next, at 802, the method includes choosing a fuel injector clamp design based on system parameters. The clamp design may involve factors such as overall clamp size, shape of the fuel injector receiving portion of the clamp, strength requirements based on compressive force, and size of the fastener to hold the clamp to the cylinder head or other engine component. Next, at 803, the method includes choosing a manufacturing process for creating the fuel injector clamp based on the fuel injector clamp design. Other processes besides casting and stamping may include forging, molding, forming, and machining, among others. In one example, as previously mentioned, depending on the engine system, the fuel injector clamp can be stamped according to the general design of clamp 200 that is conducive to the stamping process with the benefits outlined above. Lastly, at 804, the method includes performing a series of manufacturing steps to produce the fuel injector clamp. For example, the steps may include material selection, pre-fabrication, fabrication, and post-fabrication such as heat treatment. Other variations of method 800 for producing the fuel injector clamps are possible while remaining within the scope of the present disclosure.

In addition to the benefits regarding material selection, costs, and simplicity of stamping over casting processes, several design features of clamp 200 are described hereafter that may be advantageous over other clamp designs. First, the general thickness of clamp 200 as shown by top wall 445 in the cross-section of FIG. 4 may be selected based on strength requirements of the clamp as well as geometrical constraints of the stamping process. Similarly, features such as the height of top surface 279 and rear section 245, size of corner radii such as first and second concave surfaces 212 and 222, and recessed feature 235 may be selected to meet the strength and stamping requirements. Furthermore, the shape of the top area of clamp 200 defined by hole 230, recessed feature 235, and top surface 279 may be formed by a coining process. In other clamp designs, the hole 230 may be raised above the plane of top surface 279, thereby forming a protruded boss feature. With the stamped manufacturing process, multiple heat treatments can be used to produce different qualities in the finished clamp. For example, upon being stamped into a final shape, the clamp 200 is subjected to carburization, wherein the steel of the clamp absorbs carbon in a controlled, carbon-rich environment until the effective case depth reaches between 0.3-0.7 millimeters. Next, the clamp is moved to another environment where it is tempered at 410° C. until the desired properties of the clamp are achieved. The properties may include compressive and tensile strength, hardness, and ductility. Furthermore, utilizing the diesel fuel injector clamp 200 achieves the technical effect of conforming to a variety of shapes depending on the particular fuel injector and engine system setups, wherein the stamping process can be modified to change the shape of the fuel injector clamp.

A coining process can also be used to form nose section 548, wherein the nose section forms a generally circular shape extending across the top of rear section 245. Furthermore, indent 253 can be formed through the stamping process such that the indent provides proper assembly clearance between the fuel injector and clamp, including legs 210 and 220 as well as other portions of clamp body 207. The width and height of legs 210 and 220 may be chosen to meet clamping and strength requirements of clamp 200 in order to securely hold the fuel injector to the cylinder head, as described previously with regard to FIG. 1. The height of the main body 207, that is, the distance along vertical axis 251 between bottom surface 277 and top surface 279, can be chosen in some embodiments to determine the length of the fastener 190 as shown in FIG. 1. In particular, the unthreaded shank may fit along the height of clamp 200 inside hole 230 and cavity 206 while the threaded shank may fasten into the cylinder head to provide the clamping force in the fastener, clamp 200, and fuel injector. The head of the fastener along with the one or more washers can rest against the recessed feature 235 surrounding hole 230 or other areas of top surface 279.

As described herein, the injector clamp may be formed by a stamping process, and thus the structure of the injector clamp as described herein may be particularly shaped to advantageously enable improved stamping operation. For example, the interior cavity 206 may be shaped such that the horizontal cross-sectional area only becomes smaller as moving from the bottom to the top of the cavity along the vertical direction. In this way, stamping processes can be made more simple and efficient requiring simple vertical motion from the die.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A fuel injector clamp, comprising:
a main body with a substantially planar top surface, the top surface including a hole protruding through the top surface into a cavity at an interior of the main body;
a front body including a first protrusion and a second protrusion projecting from the main body; and
a rear section extending from the main body to a rear surface at a lower height than the top surface.

2. The fuel injector clamp of claim 1, wherein a thickness of the main body and rear section forms the cavity at the interior of the main body, and wherein the interior cavity is shaped such that a horizontal cross-sectional area of the void formed by the cavity only becomes smaller from a bottom to a top of the cavity along a vertical direction.

3. The fuel injector clamp of claim 1, wherein the first protrusion includes a first concave surface that bridges between a first front surface and the top surface, and wherein the second protrusion includes a second concave surface that bridges between a second front surface and the top surface.

4. The fuel injector clamp of claim 1, the top surface further including a recessed feature surrounding the hole, the recessed feature generally circular and bridging a vertical length between the top surface and the hole.

5. The fuel injector clamp of claim 4, further comprising a fastener inserted through the hole to apply compressive force to the recessed feature to fix the fuel injector clamp to a cylinder head of an engine.

6. The fuel injector clamp of claim 1, further comprising a first side surface substantially parallel to a second side surface, the first and second side surfaces substantially perpendicular to the top surface.

7. The fuel injector clamp of claim 1, further comprising a bottom surface that spans undersides of the main body, front body, and rear section.

8. The fuel injector clamp of claim 1, wherein the rear section includes a coined nose section that forms a circular depression into the rear section in between the top surface and the rear surface.

9. The fuel injector clamp of claim 1, wherein the first and second protrusions include an interior surface that is adjacent to the cavity.

10. The fuel injector clamp of claim 1, wherein the fuel injector clamp is symmetric about a central axis that is substantially parallel to the top surface.

11. A stamped fuel injector clamp, comprising:
a main body with a generally constant thickness forming a cavity inside the main body, the cavity continuous with an exterior of the fuel injector clamp via an underside of the fuel injector clamp;
a front body integrated with the main body, the front body including two protrusions reducing in size as the two protrusions extend away from the main body in a first direction; and
a rear section integrated with the main body, the rear section including a rear surface located a distance away from the main body in a second direction opposite to the first direction, the rear section reducing in size in the second direction.

12. The stamped fuel injector clamp of claim 11, further comprising a hole located in the main body, the hole creating a continuous connection between the exterior of the fuel injector clamp and the cavity.

13. The stamped fuel injector clamp of claim 11, wherein the two protrusions each include a front surface defining a first end of the fuel injector clamp in the first direction.

14. The stamped fuel injector clamp of claim 13, wherein the rear surface defines a second end of the fuel injector clamp in the second direction, the rear surface and front surfaces substantially parallel.

15. The stamped fuel injector clamp of claim 11, further comprising a generally circular recessed feature that surrounds the hole.

16. A fuel injector clamp assembly, comprising:
an engine including a cylinder block and a cylinder head, the cylinder head removably attached to the cylinder block, wherein attachment between the cylinder head and cylinder block forms a plurality of cylinders;
a plurality of fuel injectors, each coupled to one of the plurality of cylinders and provided fuel from a fuel system; and
a plurality of fuel injector clamps, wherein each clamp fixes each fuel injector to the cylinder head via a fastener, and wherein each of the plurality of fuel injector clamps includes a curved main body with a central hole and two protrusions extending from a first side of the main body and a rear section extending from a second side of the main body, the first side opposite to the second side, the rear section reducing in size as it extends from the main body.

17. The fuel injector clamp assembly of claim 16, wherein the cylinder head further comprises geometry to receive and seat the plurality of fuel injector clamps.

18. The fuel injector clamp assembly of claim 16, wherein the two protrusions reduce in size as the two protrusions extend from the first side of the main body.

19. The fuel injector clamp assembly of claim 16, wherein the main body further includes an indent positioned in between the two protrusions, the indent shaped to receive a mating surface of the fuel injector.

20. The fuel injector clamp assembly of claim 16, wherein a fuel injector receiving space is formed between the two protrusions, indent, and main body.
